(19) United States
(12) Patent Application Publication
(10) Pub. No.: US 2025/0036136 A1
(43) Pub. Date: Jan. 30, 2025

(54) TRAFFIC CONTROL SYSTEM AND METHOD

(71) Applicant: KEYSTONE HUMANS INC., San Diego, CA (US)

(72) Inventors: Arturo Jesus FARIAS SERRA, Gibsons (CA); Juan Pablo RICO GARCIA, San Diego, CA (US)

(73) Assignee: KEYSTONE HUMANS INC., San Diego, CA (US)

(21) Appl. No.: 18/711,422

(22) PCT Filed: Nov. 21, 2022
(86) PCT No.: PCT/US2022/050546

§ 371 Date: May 17, 2024

Related U.S. Application Data
(60) Provisional application No. 63/281,269, filed on Nov. 19, 2021.

(51) Int. Cl. G05D 1/247; G05D 1/229; G08G 1/01; G08G 1/0967

(52) U.S. Cl. CPC G05D 1/247; G05D 1/229; G08G 1/0137; G08G 1/096733

(57) ABSTRACT

A system and method are disclosed herein that are configured to direct traffic along a guideway. The system and method are configured to allow a user to enter the guideway and travel along an optimized route based on a comparison of routes between a predetermined origin and destination. Various slots are defined along the guideway and the control server is configured to direct vehicles into predetermined slots based on tracking information for the vehicles.

### CROSS REFERENCE TO RELATED APPLICATION

This application claims the benefit of U.S. Provisional Application No. 63/281,269, which was filed Nov. 19, 2021 and is incorporated herein by reference as if fully set forth.

### FIELD OF THE INVENTION

This disclosure is generally related to a traffic control system and method.

### BACKGROUND

There is a general need to improve traffic flow in multiple types of applications. Backups or other delays with respect to the flow of traffic can cause significant losses in terms of productivity, monetary losses, and other undesirable impacts.

In transportation or communication networks, there is often the challenge of routing the vehicles or packages so that they arrive at their destination while optimizing certain parameters such as early arrival, speed, cost, etc. The obstacles to achieving these goals often center on finding optimal routes and avoiding congestion (i.e., traffic jams and collisions) of vehicles or packages that might negatively impact the desired parameters. This applies to autonomous vehicles or packages and to driven vehicles or packages. In particular, the flow of traffic for commuters or other travelers is a constant issue which is difficult to address. Commuters are generally free to drive their vehicles at any given speed and in any manner, pursuant to any local speed regulations or ordinances. Entering and exiting highways or large streets also is a known cause of multiple traffic jams or backups due to inefficiencies in driving patterns by commuters. In another case, autonomous vehicles, directly or through a central control agent, must determine a route, deal with unexpected conditions and obstacles, and simultaneously manage a large number of factors. This can result in extreme complexity and therefore cost and unpredictability.

It would be desirable to provide a solution that helps avoid traffic congestion and optimizes the flow of traffic.

### SUMMARY

In an aspect, the invention relates to a system and method configured to provide routes for vehicles traveling along a guideway. The system comprises a control server, a guideway defining a plurality of waypoints, a plurality of control beacons, and a plurality of vehicles configured to travel along the guideway based on commands from the system.

In an aspect, the invention relates to a control system for controlling one or more vehicle travelling along a guideway. The control system comprises a control server and at least two beacon devices. The guideway comprises a plurality of slots that move along the guideway at a slot speed, wherein the slots are virtual spaces dividing the guideway and assigned and moved virtually along a representation of the guideway within the control system. The control server is configured to identify a plurality of waypoints along the guideway, each waypoint comprising a point of transition for the vehicle along the guideway. The control server is further configured to assign a slot status for each slot, where the slot status comprises an occupancy signal indicating whether the respective slot is occupied. The control server is further configured to determine, based on the slot status for each slot, a route along the guideway between a point of origin for a vehicle and a point of destination for the vehicle, wherein each waypoint along the route is not occupied at a calculated moment the vehicle would encounter the waypoint. The at least two beacon devices are configured to transmit a control signal configured to be received by the vehicle to control a vehicle speed of the vehicle such that the vehicle maintains a position within one of the plurality of slots along the route.

In an aspect, the invention relates to an improved method for controlling one or more vehicle travelling along a guideway by a control system. The control system comprises a control server and at least two beacon devices. The guideway comprises a plurality of slots that move along the guideway at a slot speed, wherein the slots are virtual spaces dividing the guideway and assigned and moved virtually along a representation of the guideway within the control system. The method comprises the control server identifying a plurality of waypoints along the guideway, each waypoint comprising a point of transition for a vehicle along the guideway. The method also comprises the control assigning a slot status for each slot, where the slot status comprises an occupancy signal indicating whether the respective slot is occupied, and the control server determining, based on the slot status for each slot, a route along the guideway between a point of origin for the vehicle and a point of destination for the vehicle, wherein each waypoint along the route is not occupied at a calculated moment the vehicle would encounter the waypoint. The method also comprises the at least two beacon devices transmitting a control signal configured to be received by the vehicle to control a vehicle speed of the vehicle such that the vehicle maintains a position within one of the plurality of slots along the route.

Arrangements with one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1 is an exemplary flowchart diagram showing aspects of a control system.

FIG. 2 is a schematic diagram of one aspect of the control system.

### DETAILED DESCRIPTION

In an embodiment, this disclosure is directed to a rapid transit type control. However, one of ordinary skill in the art would understand that this improved traffic control system is applicable to any type of transport system where multiple vehicles or packages, real or virtual, travel along a network of routes or guideways.

Systems and methods herein relate to improved traffic control. The improvement may be that congestions are avoided and/or travel times are reduced or minimized.

A mechanism for an improved traffic control system is described herein in which routes are assigned to vehicles entering guideways such that traffic can merge and join the guideways with traffic travelling at a fixed speed.

In an embodiment, the improved traffic control system comprises the following components: A network of interconnected dedicated guideways along which autonomous vehicles can travel. In an embodiment, the guideways include one or more of rails, roads, tubes, frames, or other conduits that are generally configured to allow the flow of traffic or configured to propel traffic thereon. A guideway may include lanes.

In an embodiment, there are one or more of beacons and waypoints along a guideway(s). The guideways can be in any form, shape, configuration, etc.

Beacons comprise spaced markers along a guideway. In an embodiment, beacons are regularly spaced from each other. In an embodiment, a set of beacons or all beacons are configured to communicate with a central computer, processor, or network. In an embodiment, beacons can also be configured to communicate with each other.

Waypoints are points on a guideway at which traffic can enter and exit the guideway.

In an embodiment, traffic comprises vehicles or pods, packages or information packages, which are preferably autonomous. The traffic travels along the guideways. The vehicles or pods can be configured to be propelled along the guideways via the system, or the vehicles or pods can include standalone propulsion systems.

During operation, a user activates an application or accesses an interface. In an embodiment, the application can be a smartphone application. The skilled artisan will understand that various types of interfaces could be used. The user can access the application to request a ride from an origin or initial waypoint to a destination or final waypoint in the network. Additionally, the user may add intermediate stops to the travel route.

In an embodiment, the traffic control system comprises a control server configured to determine and find possible routes from the origin to destination. In an embodiment, the control server is configured to perform a comparison function in which the traffic control system is configured to select the route with the quickest arrival time to the destination. As compared to known GPS traffic apps or other tools, the present disclosure provides a predictable and controlled traffic management system because the route of every vehicle is known before the vehicle enters the guideway, and no two vehicles are ever assigned to the same space at the same time (which is the cause of congestion). The control server may be resident in a centralized system or distributed. The control server or elements thereof may be resident on one or more of a vehicle, a beacon, a guideway, or a waypoint, or in a another location. For example, the control server may be resident in a building but in operable communication with one or more of the control beacons, waypoints, or one or more of the vehicles. The control server may comprise a processor, a memory, and computer readable instruction resident in the memory. The computer readable instruction may embody any one or more step of any one or method herein. The computer readable instructions may be processor executable such that the control server may execute or deliver instructions to one or more of a vehicle, a beacon, a guideway, or a waypoint. Upon receipt of the instruction, the vehicle, the beacon, the guideway, or the waypoint may process and execute instructions specific for the vehicle, the beacon, the guideway, or the waypoint. To facilitate such actions, the vehicle, the beacon, the guideway, or the waypoint may include a device specific processor, memory, and RAM. One or more of the control server, one or more beacon devices, the vehicle(s), a guideway, and one or more waypoints may be in operable communication with one or more other device(s) in the system.

A vehicle, a beacon, a waypoint, a guideway, or device(s) embodying the control server may comprise wireless transmit/receive units. The wireless transmit/receive units may that configured to operate under a wireless communication method or standard. The wireless communication method or standard may be selected from any known to the skilled artisan. The data, instructions, and commands described herein may be transmitted or received by the various devices herein as will be understood by the skilled artisan. Components of computerized communication and control may be operably connected to the various components of a system herein such that a method herein may be implemented.

A vehicle is assigned to the route. The assignment may comprise a sequence of instructions for controlling the vehicle. In an embodiment, the route includes instructions for turning, stopping, starting, or other commands associated with the vehicle. This sequence of instructions may be stored in the vehicle, such as within a memory unit or other electronic data storage unit. In another embodiment, the information can be stored along the guideway in relevant waypoints. In an embodiment, the vehicles can each include GPS sensors or transponders in order to track a relative position of the vehicles along the guideways. The guideways can include sensors configured to detect the presence, speed, or other characteristics regarding the vehicles. The sensors, on the vehicle and/or the guideways, may transmit the data collected to another element of the system. The sensors, on the vehicle and/or the guideways, may transmit the data collected to the control server. The control server may receive the data, process and/or store it, and issue instructions based on the processing.

At the assigned time of departure, the vehicle can be commanded to enter the guideway at the origin waypoint. The command may be issued by the control server and received by the vehicle. The vehicle follows the assigned route by making the turns, stops and starts specified in the route. The vehicle maintains speed along the route by continually adjusting its speed according to the indications given to it by the guideway by means of the beacons.

In an embodiment, the guideway is embodied as a dedicated lane in a road, or an elevated lane or road, similar to an elevated bike or pedestrian walkway. The guideway can include entry and exit points that are embodied as on and off ramps, as those of a freeway, but smaller since the pods are smaller. The vehicles can park adjacent to a curb so that people can get on and off.

In an embodiment, the vehicles in the traffic control system are able to perform multiple functions. In an embodiment, the vehicles are configured to turn, stop and start in either direction (i.e., forward or backwards) when instructed to do so by the stored route (i.e., sequence of instructions to turn, stop or start). In an embodiment, the vehicles are also configured to maintain alignment with the center of the guideway within the tolerance set for a particular network of guideways. The tolerance in this case refers to how precisely the vehicle needs to follow the lane. For example, if the lane is 5 feet wide and the pod is 4 feet wide, then a tolerance of +/−6 inches or less could be set to avoid hitting the side walls. There may be other restrictions as well, such as the distance that the vehicle needs to maintain from the beacons for the communication between them to be effective.

In an embodiment, the vehicles are further configured to accelerate and decelerate at rates at least equal to the minimum rates set for a particular network of guideways. In an embodiment, this relates to the power that the motor and braking systems can deliver to accelerate and decelerate. The vehicles can be powered via any known means of propulsion. For example, the means of propulsion may be one or more selected from engines, motors, magnetic propulsion systems, etc.

In an embodiment, the vehicles are configured to adjust their speed by increments at least as small as required by the particular network of guideways. In an embodiment, this refers to the precision of the adjustments made each time that the vehicle is given an instruction to accelerate or decelerate. In an embodiment, the vehicles are further configured to adjust their speed with a time delay no greater than that specified for the particular network of guideways. In an embodiment, the vehicles are also configured to adjust their speed in response to at least one form of communication between the vehicle and the guideway, which may be optical, by radio signal, by sound, by physical means, or by any other means. The skilled artisan will understand that any form of communication could be used to send instructions, signals, or data to the vehicles.

In an embodiment, traffic is generally configured to be transported along the guideway at a constant set speed, at least within the vicinity of a particular beacon, in an embodiment. In an embodiment, the speed is variable. In an embodiment having a fixed or constant speed setting, for a personal rapid transit system, the set speed can be roughly 45 km/h to 65 km/h. In some instances, traffic will move at a different speed in a section of a guideway, and/or the set speed for a section of a guideway or for the entire network may be changed temporarily or permanently. In an embodiment, for any given section of the guideway, all of the vehicles traveling thereon will be moving at the same speed, and there generally is no changes in vehicle speed to accommodate for mergers with vehicles entering the guideway. In an embodiment, there is a continuous, but minor (about 1%) adjustment to vehicle speed to maintain speed within acceptable tolerance, and to maintain headway. The vehicle speed may be determined at the start of the trip, even if it changes from one section of the guideway to another, so that the vehicle's position at any time during its trip is known or determined at the start of the trip.

In an embodiment, traffic is constantly moving along the guideway at a fixed speed, and for traffic to be able to join the flow it must enter into an open “slot” in the traffic flow. Along with the initial “open slot” upon which a vehicle enters the flow at a waypoint, the traffic control system and method of an embodiment herein reserves open slots at each of the waypoints along its journey so that two or more vehicles are not assigned to the same slot. In an embodiment, this feature serves as a collision prevention feature by ensuring that two vehicles do not attempt to occupy the same space. One exemplary dimension for a slot is the distance resulting from a half-second headway. For example, if the vehicle is traveling at 50 km/h speed, then the slot would be approximately 7 meters. This size allows for a sufficient margin of error and sufficient safety parameters for placing of a pod in the slot, particularly for pods having an exemplary size of 2 to 3 meters long. A slot slightly larger than the pod would be the absolute minimum, if the speed and distance control were well, or perfectly, controlled. The skilled artisan will understand that these parameters may vary.

In an embodiment, the traffic control system and method are generally configured to allow new traffic to join the flow of traffic along a guideway without that traffic having to slow down or “make space” for the incoming vehicle. In this way, there is an improved and efficient traffic flow system.

In an embodiment, a distance is set as the amount of space allocated for each item (e.g., a vehicle or pod) along the guideway based on the speed of the guideway. This distance, at a fixed guideway speed, implies a time separation between vehicles known as “headway.” This time interval is generally also defined as a singular “tick” of the clock of the system. In one aspect, the tick can be set at one half second. The duration of a “tick,” which can be a basic time unit for the system, can be set to a predetermined interval. The tick can be considered a predetermined time interval used to measure events within the system and process. For example, the tick can be set to one second so that all events can be coordinated or reviewed and processed every second. The skilled artisan will understand that the tick duration can vary. The headway is related to the tick, in an embodiment. For example, with a headway of a half-second, if the system clock ticks every half second, then each beacon would see a vehicle or an empty slot go by exactly at every tick. This simplifies the system and makes it more convenient to calculate when the signal of the beacons changes, and when all the relevant decisions are made. In an embodiment, the ticks are used as a synchronizing unit for ensuring that the entire system remains in coordination.

In an embodiment, “ticks” are one way of referring to time, including the concept of synchronizing events. It refers to the ticks of a clock, to suggest that all components of the system can synchronize their actions to a known, constant pulse or time. In an embodiment, ticks are time intervals that can be set to a particular duration according to a specific need.

This headway allows the guideway to be divided up into “slots,” which are also known as moving blocks of space along the guideway in which a vehicle can safely fit. The slots may be in various states. For example, the slots may be “available” when no vehicle is occupying them and they are not assigned to be occupied by another vehicle at a conflicting time. The slots may be “occupied” when a vehicle is occupying the given slot. The slots may be “assigned” when no vehicle is occupying the slot but it is assigned to be occupied by another vehicle. In an embodiment, a centralized control system, computer, or processor is tracking each of the slots and their status/occupancy.

In an embodiment, when a vehicle is directed to join the flow of traffic based on a user demand, it sends a request or inquiry (for example, a “trip request”) to the system requesting a departure time and waypoint, a destination waypoint, and asking for an available time/slot upon which the vehicle can enter the flow.

In an embodiment, the traffic control system is configured to find and assign available slots to the vehicle for its entire journey to achieve the earliest possible time of arrival at the desired destination waypoint. At each waypoint, the traffic control system may be configured to determine if there will be an open slot for a given ride request.

In an embodiment, in order to set a route reservation, a rider or user first sends a “trip request” to the traffic control system containing at least the earliest time of departure, the waypoint of departure, and the destination waypoint. Additional information may be sent in the trip request, such as number of passengers, and other information.

The system maintains a database containing the status of each of the waypoints in the network of guideways for every time period or tick in the future, with a set time horizon, such as the next day or 24 hours. In an embodiment, this database can comprise a matrix or plurality of matrices. The status of each waypoint may be “available” (available for assignment) or “assigned” to a vehicle (whose identity is known and recorded in the database). The database may be configured to be constantly updating based on information received via the system. In an embodiment, sensors are implemented throughout the system and guideways for tracking multiple items of information regarding the system. The information may be stored in the database. The control server may access the database and process information therein in order to update or issue new instructions to a vehicle. Upon receipt, the vehicle may process and execute the updated or new instructions.

In an embodiment, the system maintains matrices or databases of each and all of the available routes in the system, or it may analyze the present and future states of the guideways network to find all or a set number of the possible routes that will satisfy the request made by the rider/user. In an embodiment, the system is configured to find all, or a set number of the routes that go from the origin waypoint to the destination waypoint. The system may be configured to generate a table for each possible route, in which the table includes multiple ticks for the system. The system can then calculate the time of departure requested, and look up that time in the table.

In an embodiment, if the slot at the departure time is open/available/empty, then the system is configured to look up the slot status of the next waypoint along the route, and so forth until it gets to the destination. This process can be an iterative process, in an embodiment. If no slot is available for the specified ride request, then the system will proceed to the next available tick at the origin waypoint, and perform the same checks again along the subsequent waypoints of the desired route to see if there are open slots at that tick/waypoint from origin to destination. This means that the traffic control system checks for available time slots to assign to the pod or vehicle that is requesting a departure. The system first checks if there is an available slot at the departure time requested. If that slot is available, it is assigned to the requesting pod. If it is not available, then the system checks the next time slot (i.e., the next tick), to see if it is available, and repeats the process until it finds an available slot. Since a slot will be available for all subsequent points on the guideway at least up to the next waypoint, the process is repeated at every waypoint in the route, in an embodiment. In an embodiment, the number of intermediate waypoints in a route will be very low (for example, from one and five) so the process can be done quickly by the system.

In an embodiment, once the system has calculated all the possible routes, the route with the earliest arrival time at the destination waypoint is selected and offered to the user or rider, who then may have to confirm the trip and route. If the user or rider does not approve of the route, the user or rider can request the system to determine an alternative route, in an embodiment. Once the trip is approved, the trip is then entered into the matrix or database containing the future states of all the waypoints, and the ride request is reserved for the requesting user.

In an embodiment, the traffic control system is configured to request payment from the user when requesting a ride. Various payment arrangements could be implemented with the system, such as pay as you go, subscriptions, passes, or other financial arrangements.

In an embodiment, a speed control feature is integrated with the traffic control system. The speed control feature makes it possible to determine the future position of every available or occupied slot in the guideways because the speed of the vehicles is known and constant for every section of guideway, and generally constant and uniform for all guideways and sections of guideway except the sections dedicated to acceleration and deceleration.

To maintain a constant speed, the guideway provides information to the vehicles so that the vehicles can continually adjust their speed and maintain the desired separation between vehicles, in an embodiment. In this way, the system is a smart transit control system in which all components of the system are in communication with each other.

In an embodiment, a plurality of beacons are provided along the guideway. The beacons can be provided at fixed intervals, and can be configured to send out periodic signals at fixed intervals. The intervals and timing of the signals can be configured such that one beacon sends out a signal, and the next beacon will send out the same signal after a time interval equal to the time it takes to physically travel between the two beacons at the set speed for that section of guideway. In this way, a particular signal will travel along the guideway from one beacon to the next, at the set speed of the guideway. The number and spacing of the beacons may be determined by the desired precision and the response capabilities of the specific vehicles for each designed guideway system.

In an embodiment, the beacons are small and simple devices, possibly controlled by micro-processors or control servers, that are either totally passive or with varying degrees of activity. The beacons may detect the presence or absence of a vehicle in a slot. In the case of passive beacons, they could be a variety of devices that emit signals at set intervals, like a radio transmitter, a light bulb that emits a light signal (e.g., a strobe or miniature stoplight), or a sound emitter. The beacons could alternatively be more active, as would be the case of beacons that emit a signal in response to detecting that a vehicle has just passed in front of them. The beacons can be configured to give the vehicles the information necessary for maintaining their speed and position within the expected parameters. The spacing of the beacons will be, in the case of vehicles for people travelling at 50 km/h, approximately between one and ten meters. In an embodiment, the separation would be identical to the separation between vehicles, such as approximately seven meters in this case, so that the timing of the signals and the cycling of the signals become trivial.

In an embodiment, the signals emitted by the beacons include at least two types. For example, a first signal can instruct the vehicle to speed up by a set speed increment or a set percentage speed increment. A second signal can instruct the vehicle to slow down by a set speed increment or a set percentage speed increment. In an embodiment, these signals are considered to be one common signal with varying instructions. The instruction to slow down is configured to travel ahead of the desired position “slot” for a vehicle. A gap with no signal will travel at the desired slot. The signal to speed up will travel behind the desired slot. If the signals are actual lights, with the signal to slow down being, say, red, an observer would see the red lights “move” along the guideway just ahead of where the vehicle should be, so that if the vehicle gets ahead of where it should be, it will “see” a red light and slow down. The same applies to the “speed up” signal, which will propagate along the guideway just behind where the vehicle should be, so that if it lags behind, it will see a “speed up” signal, and will correct its speed and position. The vehicle will therefore receive the correct or appropriate signal at all times to adjust its speed so that it maintains the desired speed and position in the guideway.

In an embodiment, the signals to speed up and/or slow down can be incrementally greater, so that if a vehicle is a small distance away from its desired position then the vehicle will receive an instruction to make a relatively smaller adjustment to its speed. If the vehicle is at a greater distance from its desired position then it will receive an instruction to make a relatively larger adjustment to its speed, as needed.

The signal from the beacon can be an optical signal, in an embodiment. For example, the optical signal can be analogous to the colors of a traffic stop light, with each of the colors representing different instructions. In an embodiment, the signal includes different frequencies of blinking light representing different instructions. In an embodiment, the signal is a radio signal, an auditory signal, an electrical signal, a physical signal, or any other means of transmitting a signal from the guideway to the vehicles.

The present traffic control system and method provide multiple advantages. For example, the disclosed features may allow vehicles of existing technologies, with limited autonomy (perhaps level 3 and lower) to operate with total autonomy, since most of the complications that make level 4 or 5 autonomy necessary are eliminated in this design. The skilled artisan will generally understand that level 5 vehicles are generally required to drive autonomously on generally any street or road. For systems with restricted or controlled lanes, generally level 4 autonomy would be expected, for making all the decisions necessary to enter, merge, turn and exit while interacting with other traffic. Within embodiments of the present system, that level of autonomy is not needed because the vehicles themselves do not have to make any of navigation decisions (i.e., enter, merge, turn, exit). Therefore, greater safety levels can be achieved, and third parties which have not yet achieved consistent autonomy levels of 3 and above, can be compatible with the present arrangement.

Additionally, the disclosed features in embodiments herein allow an entire city traffic network to be controlled and operated so that all or a portion of the vehicles in the network can operate autonomously. The traffic control system and method of embodiments herein also allows any existing transit system or similar technology to operate as a network, including very dense and complex networks of guideways, such as the types of transit systems in congested city centers. The method and traffic control system of embodiments herein also allow different vehicles, with different characteristics (i.e., autonomy levels), to coexist and operate successfully in a transportation network as long as they all comply with relatively basic autonomy capabilities.

In an embodiment, the guideway is a multi-purpose guideway. For example, the guideway can include a track that is configured to propel the vehicles, such as via a magnetic propulsion arrangement. The guideway can also include equipment for transmitting electronic data between beacons, which are also integrated with the guideway. In this way, the guideway can be a multi-purpose or multi-functional track that is configured to both physical propel the vehicles, as well as sending electronic data or information for the vehicles traveling thereon.

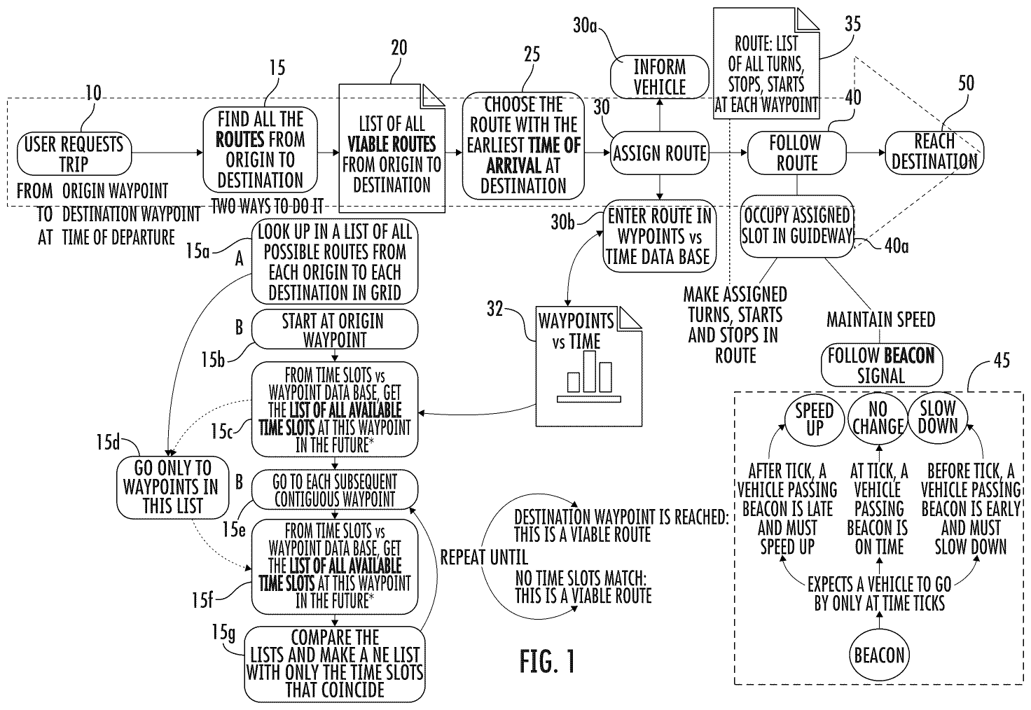

FIG. 1 illustrates a flowchart showing one exemplary arrangement for a control system and method. Specific steps are described with respect to FIG. 1. The skilled artisan will understand that any of the steps can include more features than described herein. Additionally, some steps may be implemented that are not specifically shown.

As shown in FIG. 1, step 10 includes a user requesting a trip. Step 10 can include information associated with data for an origin waypoint, a destination waypoint, and a time of departure.

Step 15 includes the system finding all possible routes between the origin and destination. This step 15 can include accessing a database of stored routes. Additionally, a processor can be used to calculate the distance and time required to travel between the origin and destination for a plurality of routes.

Once step 15 is completed, step 20 includes presenting or listing all of the possible or viable routes to a user. This list can be presented, for example, on a monitor to the user. As used in this instance, the term monitor can refer to a smartphone screen, computer screen, or other screen on an electronic device. Additionally, the data can be presented in narrative form, such as via text message or email.

As shown below steps 15 and 20 in FIG. 1, one or more processes can be implemented to find all routes between the origin and destination. For example, in one aspect, the process can involve step 15a which includes looking up a list of all possible routes from each origin to each destination in a grid or matrix. The process can then proceed to step 15d which includes only going to waypoints in the list. Step 15b can include starting at an origin waypoint. Next, step 15c includes comparing time slows versus a waypoint database, after which the system provides a list of all available time slots at a specific waypoint in the future. Step 15e includes providing a route to each subsequent contiguous waypoint along a predetermined route. Step 15f then includes comparing time slots versus a waypoint database to provide a list of all available time slots at a specific waypoint in the future. Finally, step 15g includes comparing the lists of available time slots and making a new list of time slots with only time slots that coincide. Steps 15a-15g can be implemented in an iterative process, in an embodiment. The process can be repeated until a destination waypoint is reached; i.e., a viable route is reached; or the process is repeated until no time slots match; i.e., there is not a viable route.

Step 25 includes selecting or choosing a route with an arrival time that is earliest to the destination. In an alternative arrangement, the process can select a route based on an alternative criterion.

Step 30 includes assigning a route between the specific waypoint and destination. Step 30a included informing the vehicle that a route has been assigned. Step 30b then includes entering the route in a database 32 that tracks the waypoints and time. This database is iteratively used during steps 15a-15g, and specifically used during step 15c. In this way, each time a new route is assigned for a vehicle, that information or data is tracked and communicated within the system to be used during subsequent route assignments and vehicle direction.

As shown in FIG. 1, the specific route 35 for each vehicle can include a plurality of parameters and datapoints. For example, the route 35 can include a list of all turns, stops, starts, etc. for each waypoint. The route 35 can include directive information that controls and assigns directional information for the vehicle.

At step 40, the vehicle is directed to follow the predetermined or assigned route. Associated step 40a includes sending information to the system that indicates the specific vehicle is occupying an assigned slot in the guideway.

Various directional and control parameters can be used while the vehicle travels on the guideway. Step 45 illustrates one set of exemplary control arrangements. For example, a beacon signal can be used that includes at least three indicators for the vehicles traveling on the guideway. In an embodiment, a green signal can be used to indicate to a vehicle to speed up, a yellow signal can be used to indicate that the vehicle should maintain its speed, and a red signal can be used to indicate that a vehicle should slow down. These beacons or signals can be provided at “ticks” or incremental markers along the guideway. After the respective signal or beacon, the vehicle can be automatically controlled to either speed up, maintain its speed, or slow down. The beacons can transmit more granular instructions to the vehicles such as to speed up or slow down by a predetermined velocity and acceleration. The beacons receive information from the system to precisely transmit their signals to the vehicles at the moment the vehicles are expected to travel past the beacons. Finally, step 50 includes the vehicle reaching its particular destination.

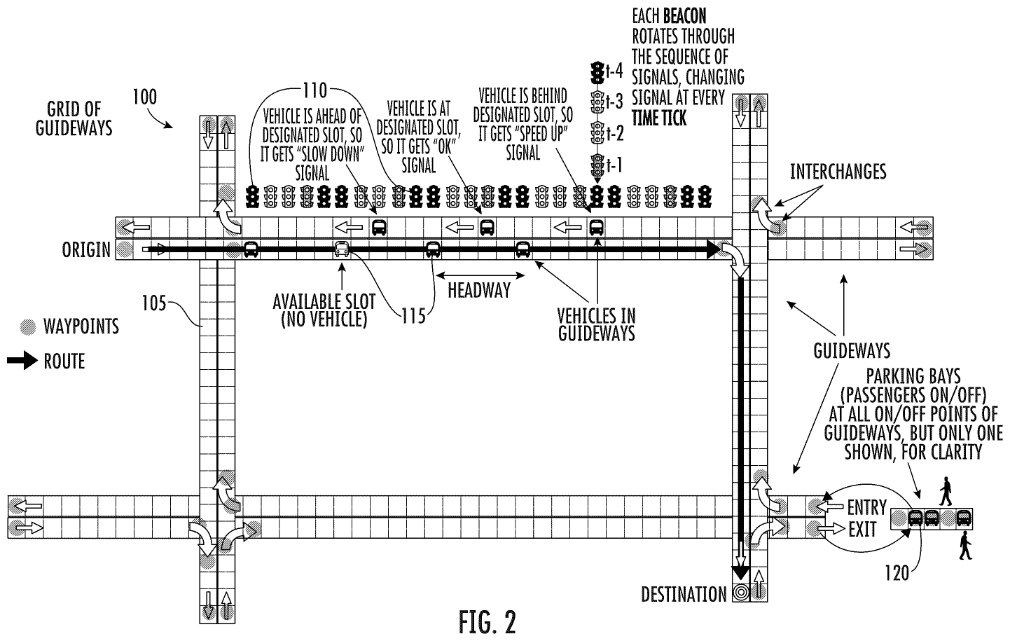

FIG. 2 illustrates an embodiment of a traffic control system 100. As shown in FIG. 2, a grid of guideways 105 are provided that generally define tracks or paths for vehicles 115 to travel along. The contours, shapes, lengths, etc. of the guideways can vary and are illustrated in a simple grid in FIG. 2 for illustrative purposes only. A plurality of beacons 110 are arranged along the guideways 105. Each of the beacons 110 can have a varying state.

If a vehicle 115 is behind schedule, then the beacon 110 in the vicinity of that vehicle 115 will receive a message or signal to speed up. If a vehicle 115 is ahead of schedule, then the beacon 110 in the vicinity of that vehicle 115 will receive a message or signal to slow down. If a vehicle 115 is at a designated or predicted area along the guideway 105, then the beacon 110 in the vicinity of that vehicle 115 will receive a message or signal that to maintain its speed. A predetermined headway is defined along the guideway between two adjacent vehicles. An available vehicle slot can be defined along the guideway if there is sufficient space (i.e., headway) to receive a vehicle in a predetermined area of the guideway.

Bays 120, such as parking bays, can be provided that allow passengers to board and exit the system. Within the parking bay 120, multiple vehicles can be parked or otherwise stationary, thereby allowing users to enter and exit. A plurality of bays 120 can be arranged throughout the system, although only one bay 120 is shown in FIG. 2.

A central database or control system can be implemented to carry out the various signal processing, input/output, data storage, algorithms, and other electronic data and information aspects of the present disclosure. In an embodiment, the central database can include at least one central processing unit (CPU), a server, and internet connection. The control system can include a plurality of CPUs connected with each other via a network to carry out the various aspects of the present disclosure. The skilled artisan will understand that various arrangements could be used.

In an embodiment, the system described herein can be implemented in which the guideway is a highway or other street, and the vehicles are autonomous vehicles, such as autonomous automobiles.

In an embodiment, all vehicles enter the guideways at end points or on/off ramps only, and never at random points. Furthermore, each vehicle occupies an assigned slot throughout its trip, and therefore when vehicles merge onto traffic, they do so exclusively into empty slots, assigned to them by the control system. Therefore, no vehicle ever slows down or makes another slow down due to entering or exiting the system.

In an embodiment, the guideway can be configured to just guide or provide tracks for the vehicles, or the guideway can be configured to propel vehicles.

In an embodiment, the beacons may be omitted, particularly if the vehicles or another system integrated therein is used to maintain the speed and position of the vehicles.

An embodiment comprises a control system for controlling one or more vehicle travelling along a guideway. The control system comprises a control server and at least two beacon devices.

In an embodiment, the control system may comprise one or more vehicles and/or one or more databases.

One or more of the control server, the at least two beacon devices, and one or more vehicles when present may comprise one or more of a processor, RAM, and a computer-readable memory. The computer-readable memory may comprise processor executable instructions for conducting at least the portions of a method herein. The control server may be a specialized computer for conducting the steps of a method herein.

The guideway may comprise a plurality of slots that move along the guideway at a slot speed. The slot speed may be a constant speed. The slot speed may vary. The reason to vary the slot speed may include traffic demands, time of day, or the like. The slots are virtual spaces dividing the guideway and assigned and moved virtually along a representation of the guideway within the control system. A vehicle may be described as in a slot when it is on the guideway in a physical position corresponding to the virtual space. The plurality of slots may comprise a length. The length may be equal to a distance between two adjacent beacon devices of the at least two beacon devices. Each beacon device may be separated by a uniform distance from each of its neighboring, or adjacent, beacon devices. That is, the length may be the distance between each adjacent pair of the at least two beacon devices.

The control server may be configured to identify a plurality of waypoints along the guideway. Each waypoint may comprise a point of transition for the vehicle along the guideway.

The control server may be further configured to assign a slot status for each slot. The slot status may comprise an occupancy signal indicating whether the respective slot is occupied. The occupancy signal, as used herein, is a data point.

The control server may be further configured to determine, based on the slot status for each slot, a route along the guideway between a point of origin for a vehicle and a point of destination for the vehicle. In an embodiment, the determining is based upon each waypoint along the route being not occupied at a calculated moment the vehicle would encounter the waypoint.

The at least two beacon devices are configured to transmit a control signal configured to be received by the vehicle to control a vehicle speed of the vehicle such that the vehicle maintains a position within one of the plurality of slots along the route.

The at least two beacon devices may be configured to transmit to transmit the control signal in a cycle of instructions. The at least two beacon devices may be configured to repeat the cycle of instructions over a time interval.

In an embodiment, the control signal is a cycle of commands to speed up, to maintain speed, and to slow down and the at least two beacon devices are configured to repeat the cycle at a regular interval. In an embodiment, the regular interval is matched with the speed such that (a) when the vehicle arrives proximal to the transmitting beacon at a time later than expected for the position within one of the plurality of slots along the route the command speed up is the command being transmitted, (b) when the vehicle arrives proximal to the transmitting beacon at a time expected for the position within one of the plurality of slots along the route the command maintain speed is the command being transmitted, and (c) when the vehicle arrives proximal to the transmitting beacon at a time earlier than expected for the position within one of the plurality of slots along the route the command slow down is the command being transmitted. The beacons may transmit the control signal without receiving or detecting the position of any vehicle.

The guideway may comprise a plurality of paths. The plurality of waypoints may comprise one or more selected from a point of entry for the vehicle to the guideway, a point where two or more of the plurality of paths merge, a point where two or more of the plurality of paths diverge, a point where two more of the plurality of paths intersect, and an exit for the vehicle from the guideway.

The control server may be configured to assign the route to the vehicle.

The control server may be configured to instruct propulsion of the vehicle along the route. The vehicle may be configured to receive the route and based on the route conduct propulsion of the vehicle along the route.

The control server may be configured instruct the vehicle to execute a sequence and number of self-instructions to propel the vehicle along the route. The self-instructions may comprise one or more of move right, move left, start, or stop. The sequence and number of instructions may be ordered to complete the route. The control server may be configured to create and transmit the sequence and number of self-instructions to the vehicle. The vehicle may be configured to execute the sequence and number of self-instructions.

In an embodiment, the control system further comprises a database configured to store the slot status for each slot over time.

The at least two beacon devices may be configured to issue operational commands to the vehicle.

The control server may be configured to track the vehicle and at least one other vehicle versus the slot statuses and the waypoints to calculate travel time to destination for the vehicle. The control serve may be further configured to determine a new route based on the travel time, and assign the new route to the vehicle.

The control server may be configured to receive a trip request from a user interface. The trip request may include the point of origin and the point of destination. The user interface could be a mobile device used by the user.

The one or more vehicle may comprises the vehicle as described above, and at least one additional vehicle. The control server may be further configured to determine, based on the slot status for each slot, a route along the guideway between a point of origin for each respective at least one additional vehicle and a point of destination for the at least one additional vehicle, wherein each waypoint along the route is not occupied at a calculated moment the respective at least one additional vehicle would encounter the waypoint. The control signal may be further configured to be received by the at least one additional vehicle to control a vehicle speed of the each respective at least one additional vehicle such that each respective at least one additional vehicle maintains a respective position within a respective one of the plurality of slots along the route.

The control system of claim 18, the beacon devices are configured to transmit the control signal in a cycle of instructions.

In an embodiment, the control signal is a cycle of commands to speed up, to maintain speed, and to slow down and the at least two beacon devices are configured to repeat the cycle at a regular interval, and wherein the regular interval is matched with the speed such that (a) when a respective at least one additional vehicle arrives proximal to the transmitting beacon at a time later than expected for the respective position within one of the plurality of slots along the route the command speed up is the command being transmitted, (b) when the respective at least one additional vehicle arrives proximal to the transmitting beacon at a time expected for the position within one of the plurality of slots along the route the command maintain speed is the command being transmitted, and (c) when the respective at least one additional vehicle arrives proximal to the transmitting beacon at a time earlier than expected for the position within one of the plurality of slots along the route the command slow down is the command being transmitted.

The control server may be configured to assign a respective route to a respective at least one additional vehicle. The control server may be configured to instruct propulsion of the respective at least one additional vehicle along the respective route.

The respective at least one additional vehicle may be configured to receive the respective route and based on the respective route conduct propulsion of the vehicle along the respective route.

The control server may be configured instruct the respective at least one additional vehicle to execute a sequence and number of self-instructions to propel the respective at least one additional vehicle along the respective route. The self-instructions may comprise one or more of move right, move left, start, or stop. The sequence and number of instructions may be ordered to complete the respective route. The control server may be configured to create and transmit the sequence and number of self-instructions to the respective at least one additional vehicle. The respective at least one additional vehicle may be configured to execute the sequence and number of self-instructions.

The at least two beacon devices may be configured to issue operational commands to a respective at least one additional vehicle.

The control server may be configured to track the vehicle, and all at least one additional vehicles versus the slot statuses and the waypoints to calculate travel time to destination for the vehicle and each at least one additional vehicle. The control server may be configured to determine a new respective routes based on the respective travel times. The control server may be configured to assign the new respective route to the respective one of the vehicle and the at least one additional vehicle.

The control server may be configured to receive a respective trip request from a respect user interface. The respective trip request may include the respective point of origin and the respective point of destination for the respective additional vehicle. The respective user interface may be a mobile device.

An embodiment comprises an improved method for controlling one or more vehicle travelling along a guideway. The guideway may be part of or an object of a control system. The control system may comprise a control server and at least two beacon devices. The control system may comprise one or more vehicles. One or more of the control server, at least two beacon devices, and one or more vehicles may comprise one or more of a processor, RAM, and a computer-readable memory. The computer-readable memory may comprise processor executable instructions for conducting at least the portions of the method. The control server may be a specialized computer for conducting the method.

The guideway may comprise a plurality of slots that move along the guideway at a slot speed. The slots are virtual spaces dividing the guideway and assigned and moved virtually along a representation of the guideway within the control system.

The method comprises identifying a plurality of waypoints along the guideway, each waypoint comprising a point of transition for a vehicle along the guideway; assigning a slot status for each slot, where the slot status comprises an occupancy signal indicating whether the respective slot is occupied; and determining, based on the slot status for each slot, a route along the guideway between a point of origin for the vehicle and a point of destination for the vehicle, wherein each waypoint along the route is not occupied at a calculated moment the vehicle would encounter the waypoint. Preferably, the control server performs the identifying, assigning a slot status, and determining steps.

The method also comprises the at least two beacon devices transmitting a control signal configured to be received by the vehicle. The control signal is to control a vehicle speed of the vehicle such that the vehicle maintains a position within one of the plurality of slots along the route.

The control signal may comprise a cycle of instructions. The method may comprising the at least two beacon devices repeating the cycle of instructions over a time interval.

The transmitting a control signal may comprise transmitting a cycle of commands to speed up, to maintain speed, and to slow down and repeating the cycle at a regular interval. The regular interval may be matched with the speed such that (a) when the vehicle arrives proximal to the transmitting beacon at a time later than expected for the position within one of the plurality of slots along the route the command speed up is the command being transmitted, (b) when the vehicle arrives proximal to the transmitting beacon at a time expected for the position within one of the plurality of slots along the route the command maintain speed is the command being transmitted, and (c) when the vehicle arrives proximal to the transmitting beacon at a time earlier than expected for the position within one of the plurality of slots along the route the command slow down is the command being transmitted.

The method may further comprise assigning the route to the vehicle. Preferably, the control server conducts the assigning the route step.

The method may further comprise instructing propulsion of the vehicle along the route, which is preferably conducted by the control server.

The method may further comprise the vehicle receiving the route. The method may also comprise the vehicle, based on the route, conducting propulsion of the vehicle along the route.

The method may further comprise the control server instructing the vehicle to execute a sequence and number of self-instructions to propel the vehicle along the route. The self-instructions may comprise one or more of move right, move left, start, or stop. The sequence and number of instructions may be ordered to complete the route. The method may further comprises the control server creating and transmitting the sequence and number of self-instructions to the vehicle, and the vehicle executing the sequence and number of self-instructions.

The method may further comprise storing the slot status for each slot over time in a database.

The method may comprises the at least two beacon issuing operational commands to the vehicle.

The method may further comprise the control server tracking the vehicle and at least one other vehicle versus the slot statuses and the waypoints to calculate travel time to destination for the vehicle, determine a new route based on the travel time, and assign the new route to the vehicle.

The method may further comprise the control server receiving a trip request from a user interface. The trip request may include the point of origin and the point of destination.

The one or more vehicle in the method may comprise the vehicle and at least one additional vehicle. The method may further comprise the control server determining, based on the slot status for each slot, a route along the guideway between a point of origin for each respective at least one additional vehicle and a point of destination for the at least one additional vehicle, wherein each waypoint along the route is not occupied at a calculated moment the respective at least one addition vehicle would encounter the waypoint. Further the control signal may be further configured to be received by the at least one additional vehicle to control a speed of each respective at least one additional vehicle such that each respective at least one additional vehicle maintains a respective position within a respective one of the plurality of slots along the route. The control signal may be further configured to transmit the control signal in a cycle of instructions. The control signal may be a cycle of commands to speed up, to maintain speed, and to slow down and the method may comprise the at least two beacons repeating the cycle at a regular interval. The regular interval may be matched with the speed such that (a) when a respective at least one additional vehicle arrives proximal to the transmitting beacon at a time later than expected for the respective position within one of the plurality of slots along the route the command speed up is the command being transmitted, (b) when the respective at least one additional vehicle arrives proximal to the transmitting beacon at a time expected for the position within one of the plurality of slots along the route the command maintain speed is the command being transmitted, and (c) when the respective at least one additional vehicle arrives proximal to the transmitting beacon at a time earlier than expected for the position within one of the plurality of slots along the route the command slow down is the command being transmitted.

The method may further comprise the control server assigning a respective route to a respective at least one additional vehicle.

The method may further comprise the control server instructing propulsion of the respective at least one additional vehicle along the respective route.

The method may further comprise the respective at least one additional vehicle receiving the route and based on the respective route conducting propulsion of the vehicle along the respective route.

The method may comprise the control server instructing the respective at least one additional vehicle to execute a sequence and number of self-instructions to propel the respective at least one additional vehicle along the respective route. The self-instructions may comprise one or more of move right, move left, start, or stop. The sequence and number of instructions may be ordered to complete the respective route. The method may further comprise the control server creating and transmitting the sequence and number of self-instructions to the respective at least one additional vehicle. The method may further comprise the respective at least one additional vehicle executing the sequence and number of self-instructions.

The method may comprise the at least two beacon devices issuing operational commands to a respective at least one additional vehicle.

The method may further comprise the control server tracking the vehicle and all the at least one additional vehicles versus the slot statuses and the waypoints to calculate travel time to destination for the vehicle and each at least one additional vehicle, determining a new respective route based on the respective travel times, and assign the new respective route to the respective one of the vehicle and the at least one additional vehicle.

The method may further comprise the control server receiving a respective trip request from a respective user interface, wherein the respective trip request. The respective trip request may include the respective point of origin and the respective point of destination for the respective additional vehicle.

### Embodiments List

The following list includes particular embodiments herein. Embodiments otherwise described herein are not excluded from the scope of the disclosure herein even if they are not listed in the following lists.

1. A control system for controlling one or more vehicle travelling along a guideway, the control system comprising: a control server and at least two beacon devices; the guideway comprising a plurality of slots that move along the guideway at a slot speed, wherein the slots are virtual spaces dividing the guideway and assigned and moved virtually along a representation of the guideway within the control system; the control server configured to identify a plurality of waypoints along the guideway, each waypoint comprising a point of transition for the vehicle along the guideway; the control server further configured to assign a slot status for each slot, where the slot status comprises an occupancy signal indicating whether the respective slot is occupied; the control server further configured to determine, based on the slot status for each slot, a route along the guideway between a point of origin for a vehicle and a point of destination for the vehicle, wherein each waypoint along the route is not occupied at a calculated moment the vehicle would encounter the waypoint; and the at least two beacon devices configured to transmit a control signal configured to be received by the vehicle to control a vehicle speed of the vehicle such that the vehicle maintains a position within one of the plurality of slots along the route.

2. The control system of embodiment 1, wherein the slot speed is a constant speed.

3. The control system of one or more of embodiments 1 or 2, wherein the plurality of slots comprises a length, the length is equal to a distance between two adjacent beacon devices of the at least two beacon devices.

4. The control system of embodiment 3, wherein the length is the distance between each adjacent pair of the at least two beacon devices.

5. The control system of any one or more of embodiments 1-4, wherein the at least two beacon devices configured to transmit the control signal configured to be received by the vehicle are further configured to transmit the control signal in a cycle of instructions.

6. The control system of embodiment 5, wherein the at least two beacon devices are further configured to repeat the cycle of instructions over a time interval.

7. The control system of any one or more of embodiments 1-6, wherein the control signal is a cycle of commands to speed up, to maintain speed, and to slow down and the at least two beacon devices are configured to repeat the cycle at a regular interval, and wherein the regular interval is matched with the speed such that (a) when the vehicle arrives proximal to the transmitting beacon at a time later than expected for the position within one of the plurality of slots along the route the command speed up is the command being transmitted, (b) when the vehicle arrives proximal to the transmitting beacon at a time expected for the position within one of the plurality of slots along the route the command maintain speed is the command being transmitted, and (c) when the vehicle arrives proximal to the transmitting beacon at a time earlier than expected for the position within one of the plurality of slots along the route the command slow down is the command being transmitted.

8. The control system of any one or more of embodiments 1-7, wherein the guideway comprises a plurality of paths, and the plurality of waypoints comprise one or more selected from a point of entry for the vehicle to the guideway, a point where two or more of the plurality of paths merge, a point where two or more of the plurality of paths diverge, a point where two or more of the plurality of paths intersect, and an exit for the vehicle from the guideway.

9. The control system of any one or more of embodiments 1-8, wherein the control server is configured to assign the route to the vehicle.

10. The control system of any one or more of embodiments 1-9, wherein the control server is configured to instruct propulsion of the vehicle along the route.

11. The control system of any one or more of embodiments 1-10, wherein the vehicle is configured to receive the route and based on the route conduct propulsion of the vehicle along the route.

12. The control system of any one or more of embodiments 1-9, where the control server is configured instruct the vehicle to execute a sequence and number of self-instructions to propel the vehicle along the route, wherein the self-instructions comprise one or more of move right, move left, start, or stop, and the sequence and number of instructions is ordered to complete the route, optionally wherein the control server is configured to create and transmit the sequence and number of self-instructions to the vehicle, and the vehicle is configured to execute the sequence and number of self-instructions.

13. The control system of any one or more of embodiments 1-12 further comprising a database configured to store the slot status for each slot over time.

14. The control system of any one or more of embodiments 1-12, wherein the at least two beacon devices are configured to issue operational commands to the vehicle.

15. The control system of any one or more of embodiments 1-12, wherein the control server is configured to track the vehicle and at least one other vehicle versus the slot statuses and the waypoints to calculate travel time to destination for the vehicle, determine a new route based on the travel time, and assign the new route to the vehicle.

16. The control system of any one or more of embodiments 1-15 wherein the control server is configured to receive a trip request from a user interface, and the trip request includes the point of origin and the point of destination.

17. The control system of any one or more of embodiments 1-16, wherein the one or more vehicle comprises the vehicle and at least one additional vehicle.

18. The control system of embodiment 17, wherein the control server is further configured to determine, based on the slot status for each slot, a route along the guideway between a point of origin for each respective at least one additional vehicle and a point of destination for the at least one additional vehicle, wherein each waypoint along the route is not occupied at a calculated moment the respective at least one additional vehicle would encounter the waypoint; and the control signal is further configured to be received by the at least one additional vehicle to control a vehicle speed of the each respective at least one additional vehicle such that each respective at least one additional vehicle maintains a respective position within a respective one of the plurality of slots along the route.

19. The control system of embodiment 18, wherein the at least two beacon devices are configured to transmit the control signal in a cycle of instructions.

20. The control system of one or both of embodiments 18 or 19, wherein the control signal is a cycle of commands to speed up, to maintain speed, and to slow down and the at least two beacon devices are configured to repeat the cycle at a regular interval, and wherein the regular interval is matched with the speed such that (a) when a respective at least one additional vehicle arrives proximal to the transmitting beacon at a time later than expected for the respective position within one of the plurality of slots along the route the command speed up is the command being transmitted, (b) when the respective at least one additional vehicle arrives proximal to the transmitting beacon at a time expected for the position within one of the plurality of slots along the route the command maintain speed is the command being transmitted, and (c) when the respective at least one additional vehicle arrives proximal to the transmitting beacon at a time earlier than expected for the position within one of the plurality of slots along the route the command slow down is the command being transmitted.

21. The control system of embodiment 18, wherein the control server is configured to assign a respective route to a respective at least one additional vehicle.

22. The control system of embodiment 21, wherein the control server is configured to instruct propulsion of the respective at least one additional vehicle along the respective route.

23. The control system of embodiment 21, wherein the respective at least one additional vehicle is configured to receive the respective route and based on the respective route conduct propulsion of the vehicle along the respective route.

24. The control system of embodiment 21, where the control server is configured instruct the respective at least one additional vehicle to execute a sequence and number of self-instructions to propel the respective at least one additional vehicle along the respective route, wherein the self-instructions comprise one or more of move right, move left, start, or stop, and the sequence and number of instructions is ordered to complete the respective route, optionally wherein the control server is configured to create and transmit the sequence and number of self-instructions to the respective at least one additional vehicle, and the respective at least one additional vehicle is configured to execute the sequence and number of self-instructions.

25. The control system of any one or more of embodiments 18-25, wherein the at least two beacon devices are configured to issue operational commands to a respective at least one additional vehicle.

26. The control system of any one or more of embodiments 18-25, wherein the control server is configured to track the vehicle, and all at least one additional vehicles versus the slot statuses and the waypoints to calculate travel time to destination for the vehicle and each at least one additional vehicle, determine a new respective routes based on the respective travel times, and assign the new respective route to the respective one of the vehicle and the at least one additional vehicle.

27. The control system of any one or more of embodiments 18-26, wherein the control server is configured to receive a respective trip request from a respect user interface, and the respective trip request includes the respective point of origin and the respective point of destination for the respective additional vehicle.

28. An improved method for controlling one or more vehicle travelling along a guideway by a control system comprising a control server and at least two beacon devices, the guideway comprising a plurality of slots that move along the guideway at a slot speed, wherein the slots are virtual spaces dividing the guideway and assigned and moved virtually along a representation of the guideway within the control system, the method comprising: the control server identifying a plurality of waypoints along the guideway, each waypoint comprising a point of transition for a vehicle along the guideway; the control assigning a slot status for each slot, where the slot status comprises an occupancy signal indicating whether the respective slot is occupied; the control server determining, based on the slot status for each slot, a route along the guideway between a point of origin for the vehicle and a point of destination for the vehicle, wherein each waypoint along the route is not occupied at a calculated moment the vehicle would encounter the waypoint; and the at least two beacon devices transmitting a control signal configured to be received by the vehicle to control a vehicle speed of the vehicle such that the vehicle maintains a position within one of the plurality of slots along the route.

29. The method of embodiment 28 the control signal comprises a cycle of instructions.

30. The method of embodiment 29 comprising the at least two beacon devices repeating the cycle of instructions over a time interval.

31. The method of embodiment 28, wherein the transmitting a control signal comprises transmitting a cycle of commands to speed up, to maintain speed, and to slow down and repeating the cycle at a regular interval, wherein the regular interval is matched with the speed such that (a) when the vehicle arrives proximal to the transmitting beacon at a time later than expected for the position within one of the plurality of slots along the route the command speed up is the command being transmitted, (b) when the vehicle arrives proximal to the transmitting beacon at a time expected for the position within one of the plurality of slots along the route the command maintain speed is the command being transmitted, and (c) when the vehicle arrives proximal to the transmitting beacon at a time earlier than expected for the position within one of the plurality of slots along the route the command slow down is the command being transmitted.

32. The method of any one or more of embodiments 28-32 further comprising the control server assigning the route to the vehicle.

33. The method of embodiment 32 further comprising the control server instructing propulsion of the vehicle along the route.

34. The method of embodiment 32 further comprising the vehicle receiving the route and based on the route conducting propulsion of the vehicle along the route.

35. The method of embodiment 32 further comprising the control server instructing the vehicle to execute a sequence and number of self-instructions to propel the vehicle along the route, wherein the self-instructions comprise one or more of move right, move left, start, or stop, and the sequence and number of instructions is ordered to complete the route, optionally further comprising the control server creating and transmitting the sequence and number of self-instructions to the vehicle, and the vehicle executing the sequence and number of self-instructions.

36. The method of any one or more of embodiments 28-35 further comprising storing the slot status for each slot over time in a database.

37. The method of any one or more of embodiments 28-36 further comprising the at least two beacon issuing operational commands to the vehicle.

38. The method of any one or more of embodiments 28-37 further comprising the control server tracking the vehicle and at least one other vehicle versus the slot statuses and the waypoints to calculate travel time to destination for the vehicle, determine a new route based on the travel time, and assign the new route to the vehicle.

39. The method of any one or more of embodiments 28-39 further comprising the control server receiving a trip request from a user interface, wherein the trip request includes the point of origin and the point of destination.

40. The method of any one of embodiments 28-39, wherein the one or more vehicle comprises the vehicle and at least one additional vehicle.

41. The method of embodiment 40 further comprising the control server determining, based on the slot status for each slot, a route along the guideway between a point of origin for each respective at least one additional vehicle and a point of destination for the at least one additional vehicle, wherein each waypoint along the route is not occupied at a calculated moment the respective at least one addition vehicle would encounter the waypoint, wherein
the control signal is further configured to be received by the at least one additional vehicle to control a speed of each respective at least one additional vehicle such that each respective at least one additional vehicle maintains a respective position within a respective one of the plurality of slots along the route.

42. The method of embodiment 41, wherein the control signal is further configured to transmit the control signal in a cycle of instructions.

43. The method of one or both of embodiments 41 or 42, wherein the control signal is a cycle of commands to speed up, to maintain speed, and to slow down and the at least two beacon devices are configured to repeat the cycle at a regular interval, and wherein the regular interval is matched with the speed such that (a) when a respective at least one additional vehicle arrives proximal to the transmitting beacon at a time later than expected for the respective position within one of the plurality of slots along the route the command speed up is the command being transmitted, (b) when the respective at least one additional vehicle arrives proximal to the transmitting beacon at a time expected for the position within one of the plurality of slots along the route the command maintain speed is the command being transmitted, and (c) when the respective at least one additional vehicle arrives proximal to the transmitting beacon at a time earlier than expected for the position within one of the plurality of slots along the route the command slow down is the command being transmitted.

44. The method of any one or more of embodiments 41-44 further comprising the control server assigning a respective route to a respective at least one additional vehicle.

45. The method of any one or more of embodiments 41-44 further comprising the control server instructing propulsion of the respective at least one additional vehicle along the respective route.

46. The method of any one or more of embodiments 41-44 further comprising the respective at least one additional vehicle receiving the route and based on the respective route conducting propulsion of the vehicle along the respective route.

47. The method of any one or more of embodiments 41-44 further comprising the control server instructing the respective at least one additional vehicle to execute a sequence and number of self-instructions to propel the respective at least one additional vehicle along the respective route, wherein the self-instructions comprise one or more of move right, move left, start, or stop, and the sequence and number of instructions is ordered to complete the respective route, optionally further comprising the control server creating and transmitting the sequence and number of self-instructions to the respective at least one additional vehicle, and the respective at least one additional vehicle executing the sequence and number of self-instructions.

48. The method of any one or more of embodiments 41-44 further comprising the at least two beacon devices issuing operational commands to a respective at least one additional vehicle.

49. The method of any one or more of embodiments 41-44 further comprising the control server tracking the vehicle and all at least one additional vehicles versus the slot statuses and the waypoints to calculate travel time to destination for the vehicle and each at least one additional vehicle, determining a new respective route based on the respective travel times, and assign the new respective route to the respective one of the vehicle and the at least one additional vehicle.

50. The method of any one or more of embodiments 41-44 further comprising the control server receiving a respective trip request from a respective user interface, wherein the respective trip request includes the respective point of origin and the respective point of destination for the respective additional vehicle.

Having thus described various embodiments of the present system and method in detail, it will be appreciated and apparent to those skilled in the art that many changes, only a few of which are exemplified in the detailed description above, could be made in the adjustable support device according to the invention without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

1. A control system for controlling one or more vehicle travelling along a guideway, the control system comprising:
a control server and at least two beacon devices;
the guideway comprising a plurality of slots that move along the guideway at a slot speed, wherein the slots are virtual spaces dividing the guideway and assigned and moved virtually along a representation of the guideway within the control system;
the control server configured to identify a plurality of waypoints along the guideway, each waypoint comprising a point of transition for the vehicle along the guideway;
the control server further configured to assign a slot status for each slot, where the slot status comprises an occupancy signal indicating whether the respective slot is occupied;
the control server further configured to determine, based on the slot status for each slot, a route along the guideway between a point of origin for a vehicle and a point of destination for the vehicle, wherein each waypoint along the route is not occupied at a calculated moment the vehicle would encounter the waypoint; and
the at least two beacon devices configured to transmit a control signal configured to be received by the vehicle to control a vehicle speed of the vehicle such that the vehicle maintains a position within one of the plurality of slots along the route.

2. The control system of claim 1, wherein the slot speed is a constant speed.

3. The control system of claim 1, wherein the plurality of slots comprises a length, the length is equal to a distance between two adjacent beacon devices of the at least two beacon devices.

4. The control system of claim 3, wherein the length is the distance between each adjacent pair of the at least two beacon devices.

5. The control system of claim 1, wherein the at least two beacon devices configured to transmit the control signal configured to be received by the vehicle are further configured to transmit the control signal in a cycle of instructions.

6. The control system of claim 5, wherein the at least two beacon devices are further configured to repeat the cycle of instructions over a time interval.

7. The control system of claim 1, wherein the control signal is a cycle of commands to speed up, to maintain speed, and to slow down and the at least two beacon devices are configured to repeat the cycle at a regular interval, and wherein the regular interval is matched with the speed such that (a) when the vehicle arrives proximal to the transmitting beacon at a time later than expected for the position within one of the plurality of slots along the route the command speed up is the command being transmitted, (b) when the vehicle arrives proximal to the transmitting beacon at a time expected for the position within one of the plurality of slots along the route the command maintain speed is the command being transmitted, and (c) when the vehicle arrives proximal to the transmitting beacon at a time earlier than expected for the position within one of the plurality of slots along the route the command slow down is the command being transmitted.

8. The control system of claim 1, wherein the guideway comprises a plurality of paths, and the plurality of waypoints comprise one or more selected from a point of entry for the vehicle to the guideway, a point where two or more of the plurality of paths merge, a point where two or more of the plurality of paths diverge, a point where two more of the plurality of paths intersect, and an exit for the vehicle from the guideway.

9. The control system of claim 1, wherein the control server is configured to assign the route to the vehicle.

10. The control system of claim 9, wherein the control server is configured to instruct propulsion of the vehicle along the route.

11. The control system of claim 9, wherein the vehicle is configured to receive the route and based on the route, conduct propulsion of the vehicle along the route.

12. The control system of claim 9, where the control server is configured instruct the vehicle to execute a sequence and number of self-instructions to propel the vehicle along the route, wherein the self-instructions comprise one or more of move right, move left, start, or stop, and the sequence and number of instructions is ordered to complete the route, wherein the control server is configured to create and transmit the sequence and number of self-instructions to the vehicle, and the vehicle is configured to execute the sequence and number of self-instructions.

13. The control system of claim 1 further comprising a database configured to store the slot status for each slot over time.

14. The control system of claim 1, wherein the at least two beacon devices are configured to issue operational commands to the vehicle.

15. The control system of claim 1, wherein the control server is configured to track the vehicle and at least one other vehicle versus the slot statuses and the waypoints to calculate travel time to destination for the vehicle, determine a new route based on the travel time, and assign the new route to the vehicle.

16. The control system of claim 1, wherein the control server is configured to receive a trip request from a user interface, and the trip request includes the point of origin and the point of destination.

17. The control system of claim 1, wherein the one or more vehicle comprises the vehicle and at least one additional vehicle.

18. The control system of claim 17, wherein the control server is further configured to determine, based on the slot status for each slot, a route along the guideway between a point of origin for each respective at least one additional vehicle and a point of destination for the at least one additional vehicle, wherein each waypoint along the route is not occupied at a calculated moment the respective at least one additional vehicle would encounter the waypoint; and
the control signal is further configures to be received by the at least one additional vehicle to control a vehicle speed of the each respective at least one additional vehicle such that each respective at least one additional vehicle maintains a respective position within a respective one of the plurality of slots along the route.

19. The control system of claim 18, wherein the control signal is further configured to be received by the at least one additional vehicle and to transmit the control signal in a cycle of instructions.

20. The control system of claim 18, wherein the control signal is a cycle of commands to speed up, to maintain speed, and to slow down and the at least two beacon devices are configured to repeat the cycle at a regular interval, and wherein the regular interval is matched with the speed such that (a) when a respective at least one additional vehicle arrives proximal to the transmitting beacon at a time later than expected for the respective position within one of the plurality of slots along the route the command speed up is the command being transmitted, (b) when the respective at least one additional vehicle arrives proximal to the transmitting beacon at a time expected for the position within one of the plurality of slots along the route the command maintain speed is the command being transmitted, and (c) when the respective at least one additional vehicle arrives proximal to the transmitting beacon at a time earlier than expected for the position within one of the plurality of slots along the route the command slow down is the command being transmitted.

21. The control system of claim 18, wherein the control server is configured to assign a respective route to a respective at least one additional vehicle.

22. The control system of claim 21, wherein the control server is configured to instruct propulsion of the respective at least one additional vehicle along the respective route.

23. The control system of claim 21, wherein the respective at least one additional vehicle is configured to receive the respective route and based on the respective route, conduct propulsion of the vehicle along the respective route.

24. The control system of claim 21, where the control server is configured instruct the respective at least one additional vehicle to execute a sequence and number of self-instructions to propel the respective at least one additional vehicle along the respective route, wherein the self-instructions comprise one or more of move right, move left, start, or stop, and the sequence and number of instructions is ordered to complete the respective route, wherein the control server is configured to create and transmit the sequence and number of self-instructions to the respective at least one additional vehicle, and the respective at least one additional vehicle is configured to execute the sequence and number of self-instructions.

25. The control system of claim 18, wherein the at least two beacon devices are configured to issue operational commands to a respective at least one additional vehicle.

26. The control system of claim 18, wherein the control server is configured to track the vehicle, and all at least one additional vehicles versus the slot statuses and the waypoints to calculate travel time to destination for the vehicle and each at least one additional vehicle, determine a new respective routes based on the respective travel times, and assign the new respective route to the respective one of the vehicle and the at least one additional vehicle.

27. The control system of claim 18, wherein the control server is configured to receive a respective trip request from a respect user interface, and the respective trip request includes the respective point of origin and the respective point of destination for the respective additional vehicle.

28. An improved method for controlling one or more vehicle travelling along a guideway in a control system comprising a control server and at least two beacon devices, the guideway comprising a plurality of slots that move along the guideway at a slot speed, wherein the slots are virtual spaces dividing the guideway and assigned and moved virtually along a representation of the guideway within the control system, the method comprising:
the control server identifying a plurality of waypoints along the guideway, each waypoint comprising a point of transition for a vehicle along the guideway;
the control server assigning a slot status for each slot, where the slot status comprises an occupancy signal indicating whether the respective slot is occupied;
the control server determining, based on the slot status for each slot, a route along the guideway between a point of origin for the vehicle and a point of destination for the vehicle, wherein each waypoint along the route is not occupied at a calculated moment the vehicle would encounter the waypoint; and
the at least two beacon devices transmitting a control signal configured to be received by the vehicle to control a vehicle speed of the vehicle such that the vehicle maintains a position within one of the plurality of slots along the route.

29. The method of claim 28, wherein the control signal comprises a cycle of instructions.

30. The method of claim 29, further comprising the at least two beacon devices repeating the cycle of instructions over a time interval.

31. The method of claim 28, wherein the transmitting a control signal comprises transmitting a cycle of commands to speed up, to maintain speed, and to slow down and repeating the cycle at a regular interval, wherein the regular interval is matched with the speed such that (a) when the vehicle arrives proximal to the transmitting beacon at a time later than expected for the position within one of the plurality of slots along the route the command speed up is the command being transmitted, (b) when the vehicle arrives proximal to the transmitting beacon at a time expected for the position within one of the plurality of slots along the route the command maintain speed is the command being transmitted, and (c) when the vehicle arrives proximal to the transmitting beacon at a time earlier than expected for the position within one of the plurality of slots along the route the command slow down is the command being transmitted.

32. The method of claim 28, further comprising the control server assigning the route to the vehicle.

33. The method of claim 32, further comprising the control server instructing propulsion of the vehicle along the route.

34. The method of claim 32, further comprising the vehicle receiving the route and based on the route conducting propulsion of the vehicle along the route.

35. The method of claim 32, further comprising the control server instructing the vehicle to execute a sequence and number of self-instructions to propel the vehicle along the route, wherein the self-instructions comprise one or more of move right, move left, start, or stop, and the sequence and number of instructions is ordered to complete the route, further comprising the control server creating and transmitting the sequence and number of self-instructions to the vehicle, and the vehicle executing the sequence and number of self-instructions.

36. The method of claim 28, further comprising storing the slot status for each slot over time in a database.

37. The method of claim 28, further comprising the at least two beacon issuing operational commands to the vehicle.

38. The method of claim 28, further comprising the control server tracking the vehicle and at least one other vehicle versus the slot statuses and the waypoints to calculate travel time to destination for the vehicle, determine a new route based on the travel time, and assign the new route to the vehicle.

39. The method of claim 28, further comprising the control server receiving a trip request from a user interface, wherein the trip request includes the point of origin and the point of destination.

40. The method of claim 28, wherein the one or more vehicle comprises the vehicle and at least one additional vehicle.

41. The method of claim 40, further comprising the control server determining, based on the slot status for each slot, a route along the guideway between a point of origin for each respective at least one additional vehicle and a point of destination for the at least one additional vehicle, wherein each waypoint along the route is not occupied at a calculated moment the respective at least one addition vehicle would encounter the waypoint, wherein
the control signal is further configured to be received by the at least one additional vehicle to control a speed of each respective at least one additional vehicle such that each respective at least one additional vehicle maintains a respective position within a respective one of the plurality of slots along the route.

42. The method of claim 41, wherein the control signal is further configured to transmit the control signal in a cycle of instructions.

43. The method of claim 41, wherein the control signal is a cycle of commands to speed up, to maintain speed, and to slow down and the at least two beacon devices are configured to repeat the cycle at a regular interval, and wherein the regular interval is matched with the speed such that (a) when a respective at least one additional vehicle arrives proximal to the transmitting beacon at a time later than expected for the respective position within one of the plurality of slots along the route the command speed up is the command being transmitted, (b) when the respective at least one additional vehicle arrives proximal to the transmitting beacon at a time expected for the position within one of the plurality of slots along the route the command maintain speed is the command being transmitted, and (c) when the respective at least one additional vehicle arrives proximal to the transmitting beacon at a time earlier than expected for the position within one of the plurality of slots along the route the command slow down is the command being transmitted.

44. The method of claim 41, further comprising the control server assigning a respective route to a respective at least one additional vehicle.

45. The method of claim 44, further comprising the control server instructing propulsion of the respective at least one additional vehicle along the respective route.

46. The method of claim 44, further comprising the respective at least one additional vehicle receiving the route and based on the respective route conducting propulsion of the vehicle along the respective route.

47. The method of claim 44, further comprising the control server instructing the respective at least one additional vehicle to execute a sequence and number of self-instructions to propel the respective at least one additional vehicle along the respective route, wherein the self-instructions comprise one or more of move right, move left, start, or stop, and the sequence and number of instructions is ordered to complete the respective route, further comprising the control server creating and transmitting the sequence and number of self-instructions to the respective at least one additional vehicle, and the respective at least one additional vehicle executing the sequence and number of self-instructions.

48. The method of claim 41, further comprising the at least two beacon devices issuing operational commands to a respective at least one additional vehicle.

49. The method of claim 41, further comprising the control server tracking the vehicle and all at least one additional vehicles versus the slot statuses and the waypoints to calculate travel time to destination for the vehicle and each at least one additional vehicle, determining a new respective route based on the respective travel times, and assign the new respective route to the respective one of the vehicle and the at least one additional vehicle.

50. The method of claim 41, further comprising the control server receiving a respective trip request from a respective user interface, wherein the respective trip request includes the respective point of origin and the respective point of destination for the respective additional vehicle.
